(19) United States
(12) Patent Application Publication
(10) Pub. No.: US 2026/0087481 A1
(43) Pub. Date: Mar. 26, 2026

(54) FACILITATOR APP FOR DISCOVERING PAYMENT APPS

(71) Applicant: MASTERCARD INTERNATIONAL INCORPORATED, Purchase, NY (US)

(72) Inventors: Ryan Watkins, Brooklyn, NY (US); Mark Robert Britten, Kilmacolm (GB)

(21) Appl. No.: 18/890,977

(22) Filed: Sep. 20, 2024

(51) Int. Cl. G06Q 20/32

(52) U.S. Cl. CPC G06Q 20/326

(57) ABSTRACT

A method is provided for conducting financial transactions with digital forms of payment. In the method, a consumer initiates a purchase on a website. A facilitator app is also initiated on the website. The facilitator app searches the electronic device being used by the consumer for payment apps that have been loaded onto the electronic device. The consumer may then select the payment app that the consumer wishes to use for the payment. The facilitator app may also launch a payment app loaded onto the electronic device and may transfer payment details from the payment app to the website.

### BACKGROUND

This disclosure relates generally to financial transaction processing, and more particularly, to improved methods for the use of digital forms of payment.

In recent years, it has become increasingly common for consumers to engage in online shopping through merchant websites. By eliminating the need to travel to a merchant's physical store, online shopping has made it more convenient and efficient for consumers to make purchases.

It has also become more common for consumers to use digital forms of payment such as digital wallets to make purchases. Digital forms of payment can be more convenient than conventional forms of payment, like physical credit and debit cards, by removing the need for the consumer to carry a physical card with them. Using digital forms of payment removes some of the risks associated with carrying physical currency including cash or physical credit and debit cards. Digital forms of payment can be more secure than physical credit and debit cards. Typically, digital forms of payment are used via various types of payment apps loaded onto a consumer's mobile device. Payment apps loaded onto a mobile device can be more secure since a consumer is likely to quickly notice that their mobile device is missing than when a physical credit or debit card goes missing, and if a consumer does lose their mobile device, passwords and other such measures on the mobile device may prevent an unauthorized individual from using any payment apps loaded on the device.

However, the increasing number of payment apps available to consumers may make it more complicated for consumers to keep track of the payment apps on their mobile phones. It can also be complicated and/or tedious to use payment apps when making purchases on merchant websites. For example, websites typically require the consumer to manually enter various information about the consumer and information about the form of payment to be used. Additionally, it can be confusing for consumers to find payment apps loaded on their mobile device and to understand how to use such payment apps to complete purchases on merchants'websites. Thus, it would be desirable to provide improved methods for using payment apps to make purchases on merchant websites.

### SUMMARY

A method is described for conducting financial transactions. A consumer may use the method by initiating a purchase on a website. A facilitator app may also be initiated on the website. The facilitator app searches the electronic device being used by the consumer for payment apps that have been loaded onto the electronic device. The facilitator app may then display a list of payment apps that are loaded on the device, and the consumer may select one of the payment apps to use for the purchase. The facilitator app may also launch a payment app that is loaded on the device. Additionally, the facilitator app may transfer payment details from a payment app to the website to complete the purchase. The invention may also include any other aspect described below in the written description or in the attached drawings and any combinations thereof.

### BRIEF DESCRIPTION OF SEVERAL VIEWS OF THE DRAWINGS

The invention may be more fully understood by reading the following description in conjunction with the drawings, in which:

FIG. 1 is a block diagram of an example multi-party payment card network system, including a first and second data center and an off-line scheduler, in accordance with one embodiment of the disclosure;

FIG. 2 illustrates a website showing a purchase being initiated;

FIG. 3 illustrates a facilitator application window showing a list of payment apps;

FIG. 4 illustrates a payment application window showing a list of payment sources;

FIG. 5 illustrates the website showing purchase details and payment details ready to complete a purchase; and

FIG. 6 illustrates a flow chart of a method for conducting a financial transaction in accordance with one embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Other aspects and example embodiments are provided in the drawings and the detailed description that follow.

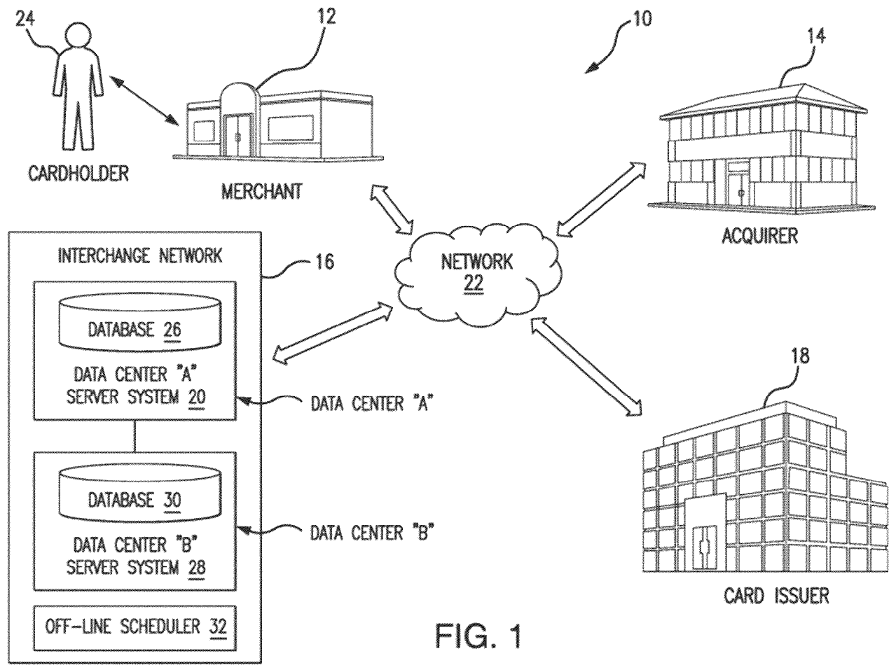

FIG. 1 is a block diagram of an example multi-party payment card network system 10, including a data center A, a data center B, and an off-line scheduler 32. The payment card network system 10 facilitates providing interchange network services offered by an interchange network 16. In addition, the payment card network system 10 enables payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

In the example embodiment, the payment card network system 10 generally includes the merchants 12, the acquirers 14, the interchange network 16, and the issuers 18 coupled in communication via a network 22. The network 22 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 22 may include more than one type of network, such as a private payment transaction network provided by the interchange network 16 to the acquirers 14 and/or the issuers 18, and separately, the public Internet, which may facilitate communication between the merchants 12, the interchange network 16, the acquirers 14, and/or cardholders 24.

Embodiments described herein may relate to a transaction card system, such as a credit card payment system using the Mastercard® interchange network. (Mastercard is a registered trademark of Mastercard International Incorporated). The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder or consumer 24, who uses the transaction card to tender payment for a purchase from the merchant 12. In the example embodiment, the merchant 12 is typically associated with products, for example, and without limitation, goods and/or services, that are offered for sale and are sold to the cardholders 24. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 24 provides payment for a purchase with a transaction card, the merchant 12 requests authorization from the acquirer 14 for the purchase amount. The request may be performed over the telephone but is usually performed using a point-of-sale terminal that reads the cardholder's account information from a magnetic stripe, a chip, or embossed characters on the transaction card and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase transaction is covered by the cardholder's available credit line. Based on these determinations, the request for authorization will be declined or accepted. If the request is accepted, an authorization code is issued to the merchant 12. Each of these transactions may be stored by the interchange network 16 in one or more tables (not shown) that make up one or more computer databases, such as databases 26 and 30. It is noted that the databases 26 and 30, described herein, may be database servers and may be discrete servers distributed remotely from one another.

When a request for authorization is accepted, the available credit line of the cardholder's account is decreased. Normally, a charge for a payment card transaction is not posted immediately to the cardholder's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 24 cancels a transaction before it is captured, a “void” is generated. If the cardholder 24 returns goods after the transaction has been captured, a “credit” is generated. The interchange network 16 and/or the issuer 18 stores the transaction data, such as, and without limitation, payment account number (PAN), a type of merchant, a merchant identifier, a location where the transaction was completed, an amount of purchase, a merchant category code, a date and time of the transaction, products purchased and related descriptions or identifiers, etc., in a transaction database, such as the databases 26 and 30.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12. It should be appreciated that more or less information related to transactions, as part of either authorization, clearing, and/or settling, may be included in the transaction data, and stored within the databases 26 and 30, at the merchant 12, the acquirer 14, the payment network 16, and/or the issuer 18. Further, transaction data, unrelated to a particular payment account, may be collected by a variety of techniques, and similarly stored within the databases 26 and 30.

In some embodiments, cardholders 24 involved in the transactions described herein are prompted to agree to legal terms associated with their payment accounts, for example, during enrollment in such payment accounts, etc. As such, the cardholder 24 may voluntarily agree to allow the merchants 12, the issuers 18, the interchange network 16, etc., to utilize data collected during enrollment and/or collected relating to processing the transactions, subsequently for one or more of the purposes described herein.

In the exemplary embodiment, the interchange network 16 includes a plurality of data centers, such as the data center A and the data center B (e.g., data centers for redundancy, data centers in distant geographical locations for network efficiency, etc.). Each data center includes a respective data center server system, such as data center A server system 20 and data center B server system 28. The server systems 20 and 28 include a plurality of applications that can be accessed by any of the merchants 12, the acquirers 14, the issuers 18, and/or the cardholders 24. The applications typically are accessed via one or more application programming interfaces (APIs).

APIs, as used herein, are how various separate services work together to deliver a solution. For example, and without limitation, in online banking, when the cardholder 24 logs in, usually the first thing the cardholder sees is his or her account balance. To deliver that solution, fundamentally two separate banking functions (or applications) work together (e.g., a login service and account balance service) to allow the cardholder 24 to see how much money he or she has in the account. How those two (2) services manage to work together is through an API. Example Mastercard APIs include, for example, Automatic Billing Updater (ABU), BIN Table Resource, MDES, Merchant Identifier, Cardless ATM, Mastercard Send, Masterpass, etc.

Referring back to FIG. 1, in the exemplary embodiment, the server systems 20 and 28 are configured to allow data, such as the transaction data, to be stored by a group of computers, and updated by one or more members of the group. While the interchange network 16 is illustrated as a single component in FIG. 1, it should be appreciated that the interchange network 16 may be a network of distributed computers or data centers, each coupled to the payment card network system 10, for example, via the network 22. For example, and without limitation, each of data centers A and B may be geographically remote from each other data center, or they may be housed in a single data center but be physically separate databases.

The off-line scheduler 32 is configured to determine a change window (e.g., a time period) for taking one or more of the plurality of applications associated with the server systems 20 and 28 off-line. In particular, the off-line scheduler 32 analyzes the applications to determine which of the one or more APIs map to the application. For each of the applications, the off-line scheduler 32 performs a failure analysis on the APIs that map to the application to determine whether any of the APIs are single point of failure (SPOF) APIs. Based on the API failure analysis, the off-line scheduler 32 assigns a priority level to the application. The off-line scheduler 32 analyzes the historical data corresponding to the volume of network traffic for the APIs. Based on the application priority level and the historical network traffic data, the off-line scheduler 32 determines a change window for taking each respective application off-line that will reduce a negative impact on the operations of, for example, the merchant 12, acquirer 14, issuer 18, cardholder 24, etc.

While only one merchant 12, acquirer 14, interchange network 16, and issuer 18 are shown in FIG. 1 (for ease of reference), it should be appreciated that a variety of other embodiments may include multiple ones of these parties in various combinations.

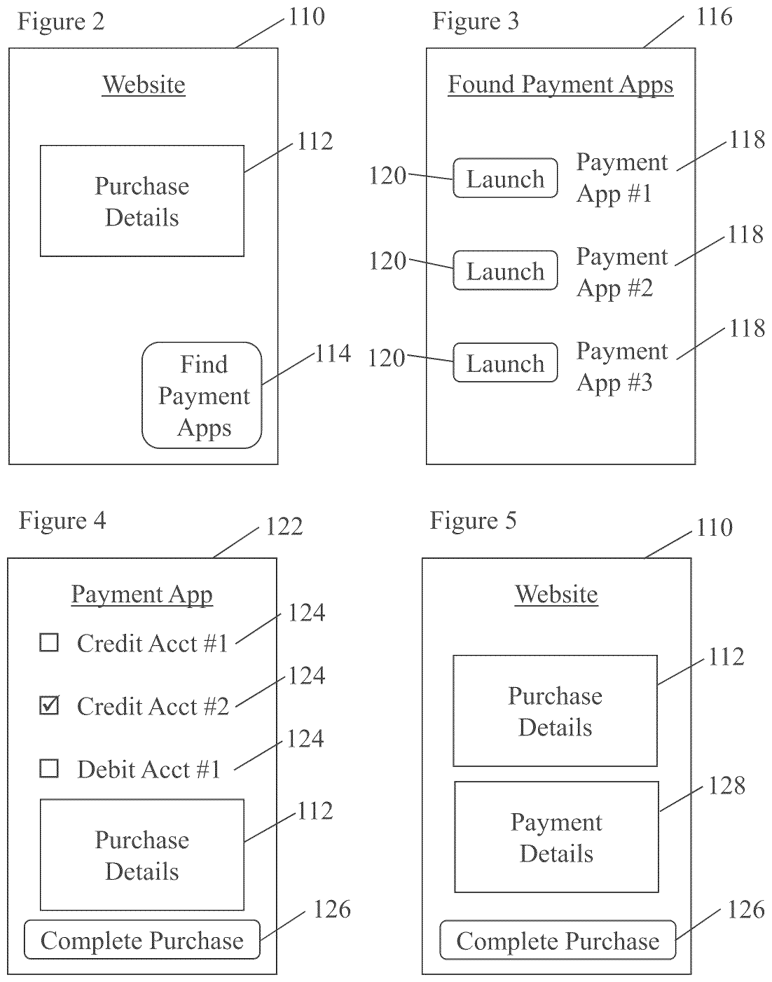

Referring now to FIG. 2, a schematic of a website 110 is shown where a consumer may shop for products to purchase. Although a consumer may use various types of electronic devices to shop on a website 110, in the preferred embodiment the consumer may use a mobile phone to access and shop on the website 110. The consumer will typically initiate a purchase on the website 110 by selecting the desired product on the merchant's website 110 and moving the product to a shopping cart 112 on the website 110. As a result, the website 110 receives a purchase indication from the consumer's mobile phone. The website 110 preferably also has a selectable link 114 (e.g., in the shopping cart 112 window) that the consumer can select (e.g., by pressing a touchscreen button 114) that helps simplify the process of completing the purchase. In the present embodiment, the selectable link 114 is labeled “Find Payment Apps”114, but it is understood that the selectable link 114 may take various forms.

When the consumer selects the Find Payment Apps link 114 on the website 110, a facilitator app is initiated and operates on the mobile phone to find payment apps 118 that have already been loaded onto the mobile phone. Preferably, the facilitator app is a software application that is able to operate on the mobile phone without having to be loaded onto the mobile phone through an app store by the consumer. For example, if the mobile phone operates on an Apple® iOS operating system, the facilitator app may be an App Clip that is designed to operate in the Apple® iOS operating system. Alternatively, if the mobile phone operates on a Google® Android operating system, the facilitator app may be an Instant App that is designed to operate in the Google® Android operating system. App Clips and Instant Apps are recognized types of software applications which are designed for small apps which can operate on a mobile phone without being loaded onto the phone by the user through an app store on the phone. In the present invention, conventional software applications that are loaded through the app store on a mobile phone are less desirable for the facilitator app since this would require an extra step to be performed by the consumer. In addition, if the facilitator app was a conventional application that requires it to be loaded onto the phone by the consumer, the Find Payment Apps link 114 on the website 110 would be non-functional until the consumer loads the facilitator app. This would create more confusion and complexity for the consumer which the present invention seeks to prevent.

Once the consumer presses the Find Payment Apps link 114, the facilitator app searches the mobile phone for any payment apps 118 that have been loaded onto the phone. Unlike the facilitator app, the payment apps 118 are software applications that are loaded onto the mobile phone in the conventional manner (e.g., using the app store on the phone). In order to use a payment app 118, the consumer will need to set up the payment app 118 beforehand with various information about the consumer and with information about forms of payment 124 the consumer plans to use. For example, the consumer may set up a payment 118 by entering their name and address and may enter one or more credit or debit card numbers 124 to use for purchases. Once the consumer has set up a payment 118, the user can use the payment apps 118 to make purchases without having to manually re-enter their name, address, credit card number 124, etc. Payment apps 118 are considered to be a digitized form of payment, and one type of payment app 118 is also known as a digital wallet 118.

Typically, in most mobile phone operating systems, facilitator apps (e.g. App Clips and Instant Apps) are not allowed by default to discover and launch other apps that have been loaded onto the mobile phone. Thus, it may be desirable in the present invention for the payment apps 118 to be programmed with a software code that makes the payment apps 118 discoverable and launchable by the facilitator app. The software code will generally be a code that is recognized by the operating system on the phone so that the operating system permits the facilitator app to search for and launch any payment apps 118 with the code which are loaded onto the phone. Once the facilitator app discovers payment apps 118 that have been loaded onto the mobile phone, the facilitator app may display a list 116 of the loaded payment apps 118 on the mobile phone as shown in FIG. 3. Thus, the facilitator app makes it easier for a consumer to use payment apps 118 on the phone since the facilitator app discovers the payment apps 118 without requiring the consumer to manually search their phone.

The consumer may then select one of the payment apps 118 to use for the purchase. As shown, launch buttons 120 may be provided with the list 116 of payment apps 118 or other types of hyperlinks may be provided to the payment apps 118. By pressing one of the launch buttons 120 in the facilitator app window 116, the facilitator app receives the selection and launches the selected payment app 118 to open a payment app window 122 as shown in FIG. 4. Thus, the consumer avoids having to search their phone for payment apps 118 loaded on the phone, and the facilitator app also makes it easy to launch the desired payment app 118. Frequently, the consumer will have set up the payment app 118 with multiple sources of payment 124. Therefore, when the desired payment app 118 is loaded, the payment app 118 will typically display a list of the sources of payment 124 that have been set up in the payment app 118.

It may be desired for the facilitator app to transfer the purchase details 112 from the merchant's website 110 to the selected payment app 122. This may be useful so that the payment app 122 can track purchases made using the payment app 122. Where purchase details 112 are transferred to the payment app 122, it may also be possible for the consumer to complete the purchase from the payment app 122 by selecting one of the sources of payment 124 set up in the payment app 122 and then selecting a Complete Purchase button 126.

It may also be desirable for the facilitator app to transfer information from the payment app 122 to the website 110 as shown in FIG. 5. For example, if the purchase is completed on the payment app 122, the facilitator app may transfer information to the website 110 indicating that the purchase has been paid for and the purchase is complete. The facilitator app may also transfer payment details 128 from the payment app 122 to the website 110. For example, the facilitator app may be able to identify which payment source 124 is the default payment source in the payment app 122 and may transfer information 128 associated with the default payment source to the merchant's website 110. This allows the consumer to supply the website 110 with a payment source 124, 128 (and related information like the consumer's name, address etc.) without having to manually enter the payment source 124, 128 into the website 110 and with the fewest possible steps. It is also possible for the payment app 122 to have a transfer button so that the consumer can choose a different payment source 124 set up in the payment app 122 and transfer that payment source information 128 to the website 110. Alternatively, if the selected payment app 122 only has one payment source 124 set up in the payment app 122 (or if a default payment source has been set), the facilitator app may transfer the payment source information 128 from the payment app 122 without launching the payment app 122. In another alternative, if the facilitator app discovers only one payment app 118 loaded onto the mobile phone, the facilitator app may skip the step of displaying a list of payment apps 118 (FIG. 3) and may directly launch the payment app 122 (FIG. 4) or may also directly transfer payment source information 128 from the payment app 122 to the website 110 (FIG. 5) without launching the payment app 122. If the purchase is to be completed on the website 110, a Complete Purchase button 126 may be pressed by the consumer once the payment source information 128 has been transferred to the website 110 in order to complete the purchase. Thus, the facilitator app allows consumers to complete purchases on a website 110 using payment apps 118 loaded on a mobile phone with a minimum of steps.

Although the preferred embodiments described herein involve a website 110 requesting and obtaining payment information 128 from a payment app 122 loaded onto the consumer's mobile phone, the inventions herein may also be used by websites to request different types of information from various apps loaded onto consumers'mobile phones. For example, a website could request a shipping address or consumer profile details (e.g., name/email/phone number) from any app (e.g., an address book) loaded onto the consumer's mobile phone. The inventions may also be used by websites to request other types of data that would be cumbersome to enter manually on a website but which is already available from an app that is already loaded onto the consumer's mobile phone.

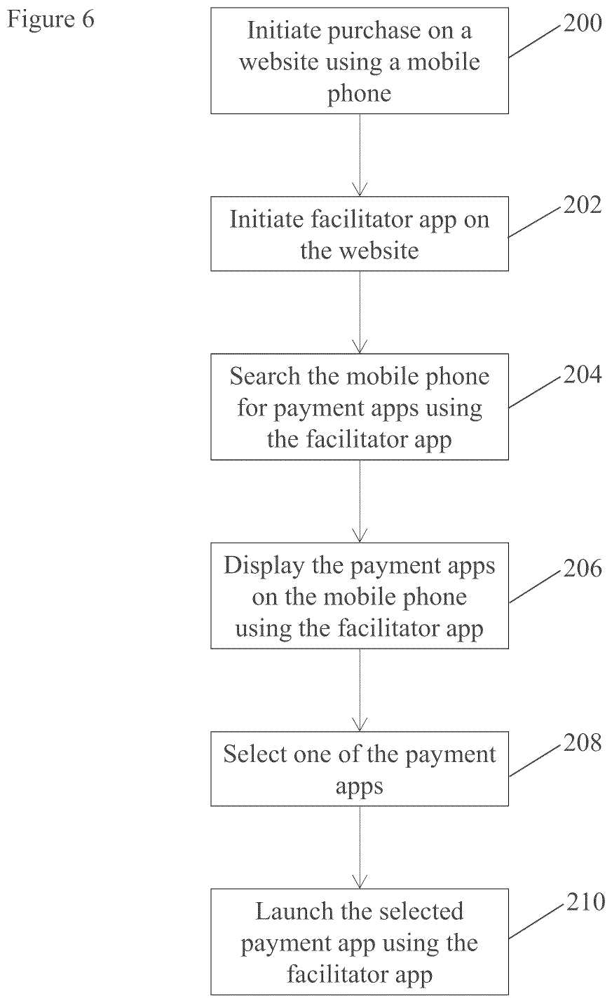

Turning to FIG. 6, a flow chart of one embodiment of the described method is shown. The method may begin by the consumer initiating a purchase on a website 110 from his or her mobile phone (200). The website 110 may then initiate a facilitator app on the website (202). The facilitator app may then search the mobile phone for one or more payment apps 118 that are already loaded onto the mobile phone (204). The facilitator app may then display the payment apps to the consumer using the mobile phone display (206). The consumer may then select one of the payment apps 118 (208). The selected payment app may then be launched on the mobile phone by the facilitator app (210).

It is understood that the described method for conducting financial transactions is intended to operate autonomously on programmed computer systems utilizing computer algorithms such that the system may be implemented by one or more computer processors (e.g., in a server system) executing computer-executable instructions stored on a non-transitory computer-readable storage medium. Thus, for example, in the case of the facilitator app and other steps described herein, it is unnecessary for human beings to make the required searches, transfers, etc. This autonomous design makes the system scalable to a level that would be impractical if human beings were to attempt to perform the steps required by the system.

While preferred embodiments of the inventions have been described, it should be understood that the inventions are not so limited, and modifications may be made without departing from the inventions herein. It should also be understood that the advantages described above are not necessarily the only advantages of the inventions, and it is not necessarily expected that all of the described advantages will be achieved with every embodiment of the inventions. The scope of the inventions is defined by the appended claims, and all devices and methods that come within the meaning of the claims, either literally or by equivalence, are intended to be embraced therein.

1. A method for conducting a financial transaction, comprising:
receiving a purchase indication on a website from a consumer electronic device;
initiating a facilitator app on the website;
searching the electronic device by the facilitator app for one or more payment apps loaded onto the electronic device;
displaying the one or more payment apps by the facilitator app on the electronic device to the consumer;
receiving a selection of one of the one or more payment apps; and
launching the selected payment app by the facilitator app on the electronic device.

2. The method for conducting a financial transaction according to claim 1, wherein the electronic device is a mobile phone.

3. The method for conducting a financial transaction according to claim 2, wherein the facilitator app operates on the mobile phone without being loaded onto the mobile phone from an app store on the mobile phone.

4. The method for conducting a financial transaction according to claim 2, wherein the mobile phone operates on an Apple® iOS operating system and the facilitator app is an App Clip designed to operate in the Apple® iOS operating system.

5. The method for conducting a financial transaction according to claim 2, wherein the mobile phone operates on a Google® Android operating system and the facilitator app is an Instant App designed to operate in the Google® Android operating system.

6. The method for conducting a financial transaction according to claim 1, further comprising transferring purchase details by the facilitator app from the website to the selected payment app.

7. The method for conducting a financial transaction according to claim 6, further comprising completing the purchase with the selected payment app.

8. The method for conducting a financial transaction according to claim 1, further comprising transferring payment details by the facilitator app from the selected payment app to the website.

9. The method for conducting a financial transaction according to claim 8, wherein the payment details comprise a default payment source in the selected payment app.

10. The method for conducting a financial transaction according to claim 8, further comprising completing the purchase on the website.

11. The method for conducting a financial transaction according to claim 1, wherein the one or more payment apps comprise a software code recognized by an operating system of the electronic device, the software code permitting the facilitator app to search for and launch the one or more payment apps.

12. The method for conducting a financial transaction according to claim 1, wherein the electronic device is a mobile phone, the facilitator app operates on the mobile phone without being loaded onto the mobile phone from an app store on the mobile phone, and the mobile phone operates on an Apple® iOS or a Google® Android operating system and the facilitator app is an App Clip designed to operate in the Apple® iOS operating system or an Instant App designed to operate in the Google® Android operating system.

13. The method for conducting a financial transaction according to claim 12, wherein the one or more payment apps comprise a software code recognized by an operating system of the electronic device, the software code permitting the facilitator app to search for and launch the one or more payment apps.

14. The method for conducting a financial transaction according to claim 13, further comprising transferring payment details by the facilitator app from the selected payment app to the website.

15. The method for conducting a financial transaction according to claim 14, further comprising completing the purchase on the website.

16. The method for conducting a financial transaction according to claim 15, wherein the payment details comprise a default payment source in the selected payment app.

17. The method for conducting a financial transaction according to claim 13, further comprising transferring purchase details by the facilitator app from the website to the selected payment app.

18. The method for conducting a financial transaction according to claim 17, further comprising completing the purchase with the selected payment app.

19. A method for conducting a financial transaction, comprising:
receiving a purchase indication on a website from a consumer electronic device;
initiating a facilitator app on the website;
searching the electronic device by the facilitator app for a payment app loaded onto the electronic device; and
launching the payment app by the facilitator app on the electronic device.

20. A method for conducting a financial transaction, comprising:
receiving a purchase indication on a website from a consumer electronic device;
initiating a facilitator app on the website;
searching the electronic device by the facilitator app for a payment app loaded onto the electronic device; and
transferring payment details by the facilitator app from the payment app to the website.
